(19) United States
(12) Patent Application Publication
(10) Pub. No.: US 2006/0204403 A1
(43) Pub. Date: Sep. 14, 2006

(54) Micro-fluidic fluid separation device and method

(75) Inventor: Gint Federas, Lafayette, CA (US)

Correspondence Address: VENABLE LLP, P.O. BOX 34385, WASHINGTON, DC, 20045-9998, US

(73) Assignee: Careside Medical, LLC, Santa Monica, CA (US)

(21) Appl. No.: 11/362,537

(22) Filed: Feb. 27, 2006

Related U.S. Application Data
(60) Provisional application No. 60/657,026, filed on Feb. 28, 2005.
(60) Provisional application No. 60/752,904, filed on Dec. 23, 2005.

(51) Int. Cl. B01L 11/00; C02F 1/02

(52) U.S. Cl. 422/101; 210/600

(57) ABSTRACT

A micro-cartridge for a fluid test device has a fluid source chamber, a particulate collection chamber, a main channel extending from the fluid source chamber to the particulate collection chamber, a liquid collection chamber, and a plurality of capillary channels extending from the main channel to the liquid collection chamber. The main channel has a width within a range of about 50 μm to 300 μm. A method of separating liquid from a composite fluid includes obtaining a sample of the composite fluid, wherein the composite fluid includes a liquid and particulate matter suspended in the liquid, and delivering at least a portion of the composite fluid near an entrance port of a main channel of a separating device. At least a portion of the composite fluid flows through the main channel and past a plurality of capillary channels of the separating device, the main channel has a width within a range of about 50 μm to 300 μm, and at least a portion of the liquid material is separated from the fluid flowing through the main channel by capillary action of the plurality of capillary channels.

### CROSS-REFERENCE TO RELATED APPLICATION

This application claims priority to U.S. application No. 60/752,904 filed Dec. 23, 2005 and U.S. application No. 60/657,026, filed Feb. 28, 2005, the entire contents of which are hereby incorporated by reference.

### BACKGROUND

1. Field of Invention

The present invention relates to a device and method for separating a liquid from a fluid having particulate matter suspended in the liquid, and more particularly to a micro-fluidic device and method for separating the liquid from the fluid.

2. Discussion of Related Art

It is often desirable to analyze various fluids by first separating out a liquid component of the fluid from the whole fluid which contains some form of particles suspended in the fluid. For example, blood tests begin by separating blood serum from whole blood which contains red blood cells, white blood cells and other particulate matter. The blood serum is a liquid which will typically contain a mixture of various proteins and other molecular components upon which various tests are typically performed. The most common blood tests require a large quantity of blood to be extracted from an individual, which is then sent to a specialized laboratory with sophisticated centrifuges and other test equipment. Such tests rely on the economy of scale by performing very large numbers of tests at the same facility in order to keep the cost relatively low. In addition to the large quantity of blood required, the cost, and the specialized techniques and equipment required to perform such a test, it takes a day or longer before the test results are known.

Careside Medical, LLC and its predecessor companies, have developed a compact, table-top centrifuge-based blood test system which requires only about 100 microliters of blood for each test and can provide results in 10 to 15 minutes. However, such a system still requires a significant investment in the cost of the machinery, the equipment requires high maintenance, and blood still has to be extracted in a significant quantity from an individual. Therefore, there is a need for systems that can provide truly point-of-care capability in which results are provided in less than 10 to 15 minutes, with less than 100 microliters of blood, and that do not require high maintenance.

### SUMMARY

A micro-cartridge for a fluid test device according to an embodiment of this invention has a fluid source chamber, a particulate collection chamber, one or more main channels extending from the fluid source chamber to the particulate collection chamber, one or more liquid collection chambers, and one or more pluralityies of capillary channels extending from the main channel(s) to the liquid collection chamber(s). Each main channel has a width within a range of about 50 μm to 300 μm. The plurality of capillary channels are each narrower than the main channel. A method of separating liquid from a composite fluid according to an embodiment of this invention includes obtaining a sample of the composite fluid, wherein the composite fluid includes a liquid and particulate matter suspended in the liquid, and delivering at least a portion of the composite fluid near an entrance port of a main channel of a separating device. At least a portion of the composite fluid flows through the main channel and past a plurality of capillary channels of the separating device, the main channel has a width within a range of about 50 μm to 300 μm, and at least a portion of the liquid material is separated from the fluid flowing through the main channel by capillary action of the plurality of capillary channels each of which are smaller in diameter than the main channels.

### BRIEF DESCRIPTION OF THE DRAWINGS

The invention is described herein, by way of example only, with reference to the accompanying figures, in which like components are designated by like reference numerals;

FIG. 1 is a schematic illustration of a point-of-care test device according to an embodiment of this invention;

FIG. 2 is a schematic illustration of the internal structure of a micro-cartridge according to an embodiment of this invention;

FIG. 3 is a schematic illustration of a portion of FIG. 2 enlarged to illustrate more detail;

FIG. 4 is a schematic illustration of a portion of a main channel according to an embodiment of this invention to describe some concepts of the invention;

FIG. 5 is a schematic illustration of a cross-section of a micro-cartridge according to an embodiment of the invention to illustrate additional concepts applicable to various embodiments of this invention;

FIG. 6 is an illustration of a portion of a main channel which is curved and illustrates additional concepts of certain embodiments of this invention; and

FIG. 7 is a schematic illustration of a portion of the main channel and a plurality of capillary channels according to an embodiment of this invention and to illustrate additional concepts of the invention.

### DETAILED DESCRIPTION

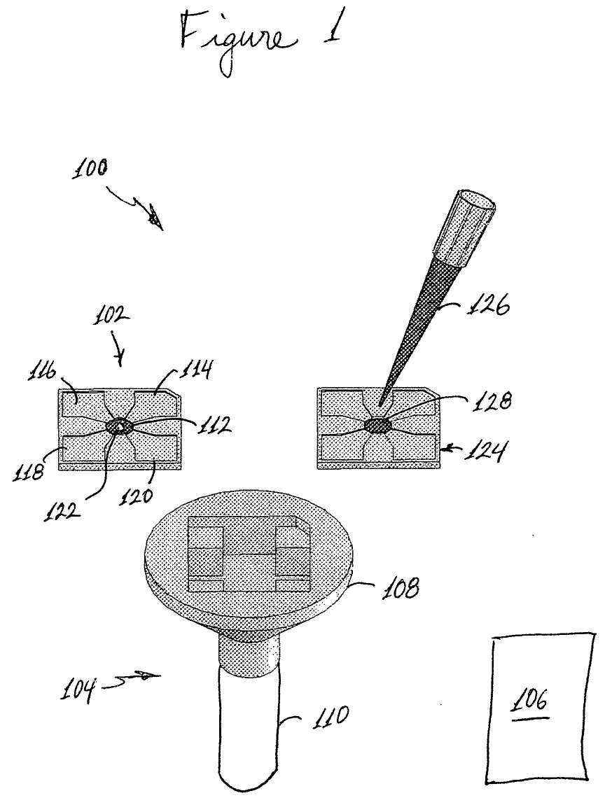

FIG. 1 illustrates a point-of-care test system 100 according to an embodiment of this invention. One application of the current invention is for a hand-held, point-of-care blood test system. Some of the detailed description will refer to such an application; however, the general aspects of this invention are not limited to only this embodiment of the invention. Although this invention is suitable for providing a system which can include a hand-held device and can be used at the point-of-care, general aspects of the invention are not limited to only hand-held and/or point-of-care systems. In addition, this invention is suitable for application to blood test equipment, but general aspects of the invention are not limited to only blood test equipment. This invention may be applied to testing other fluids in which it is desired to separate out substantially particulate free liquid from a composite fluid that contains particulate matter suspended in the liquid. Other case of interest may include, but are not limited to, spinal fluid urinalysis, hemoglobin, coagulation and DNA separation from fluids.

The point-of-care test system 100 has a micro-cartridge 102, a hand-held centrifuge 104 and a data analysis and storage component 106. The micro-cartridge 102 is received and held by cartridge holder 108 and the cartridge holder 108 is attached to the main body 110 of the hand-held centrifuge 104. Data from the hand-held centrifuge 104 may be transmitted to a data processing and storage unit 106 by either interconnected electrical and/or optical connections and/or by wireless transmission. Alternatively, data could be stored in the hand-held centrifuge 104 in storage media, such as flash memory chips, which can be removed and inserted into data processing and storage unit 106.

The micro-cartridge 102 has a fluid source chamber 112 in the center and four test regions 114, 116, 118 and 120. Details of the test regions 114, 116, 118 and 120 are not shown in FIG. 1. The regions are represented schematically in FIG. 1. Each of the four test regions, 114, 116, 118 and 120 may be constructed to perform a different test on portions of fluid provided to the respective liquid collection chamber. The “different” tests may be of the same type of test or may be different types of tests to collect different data in parallel. The micro-cartridge 102 may receive a source of fluid by a micro-needle array 122. See “Microneedle Array for Transdermal Biological Fluid Extraction and in Situ Analysis,” E. V. Mukerjee, S. D. Collins, R. R. Isseroff, R. L. Smith, Sensors and Actuators A (2004) regarding an example of a micro-needle structure, the entire contents of which are incorporated herein by reference. The micro-needle array 122 of the micro-cartridge 102 may be useful, for example, in taking a sample of blood from a patient to perform blood test analysis. Although the micro-cartridge 102 is illustrated with four test regions 114, 116, 118 and 120, the inventive micro-cartridge is not limited to any particular number of test regions. The micro-cartridge 102 may have more than four test regions, or less than four test regions. In addition, the micro-cartridge according to the current invention may be provided either with or without a micro-needle array 122. For example, one may also have a single needle structure. Micro-cartridge 124 is an example of a micro-cartridge in which a quantity of fluid may be deposited directly by an external device 126 through an opening in the micro-cartridge 124 onto a fluid source chamber 128.

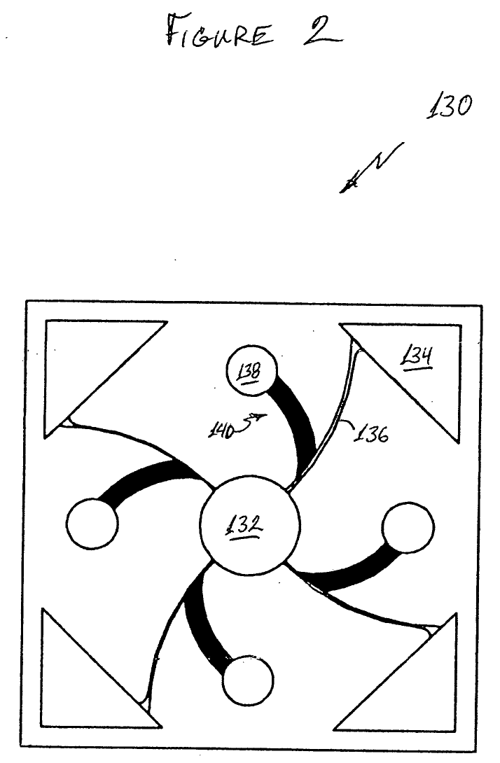

FIG. 2 is an illustration of a micro-cartridge 130 according to an embodiment of this invention. The micro-cartridge 130 has a fluid source chamber 132 defined by structures of the micro-cartridge 130. The fluid source chamber 132 is located substantially at the center of the micro-cartridge 130 and the micro-cartridge 130 is adapted to be rotated about an axis substantially going through the center of the fluid source chamber 132 by the hand-held centrifuge 104.

The micro-cartridge 130 is an example of a micro-cartridge having four test regions. In this example, each test region is substantially the same as the other test regions but rotated 90° through the axis perpendicular to the plane of the paper, substantially through the center of the fluid source chamber 132. One may construct the structures of each of the plurality of test regions to be substantially the same, or one may construct them to have different structures, depending on the desired application. In this example, we will describe the structures of one test region in more detail, which similarly describes the other test regions.

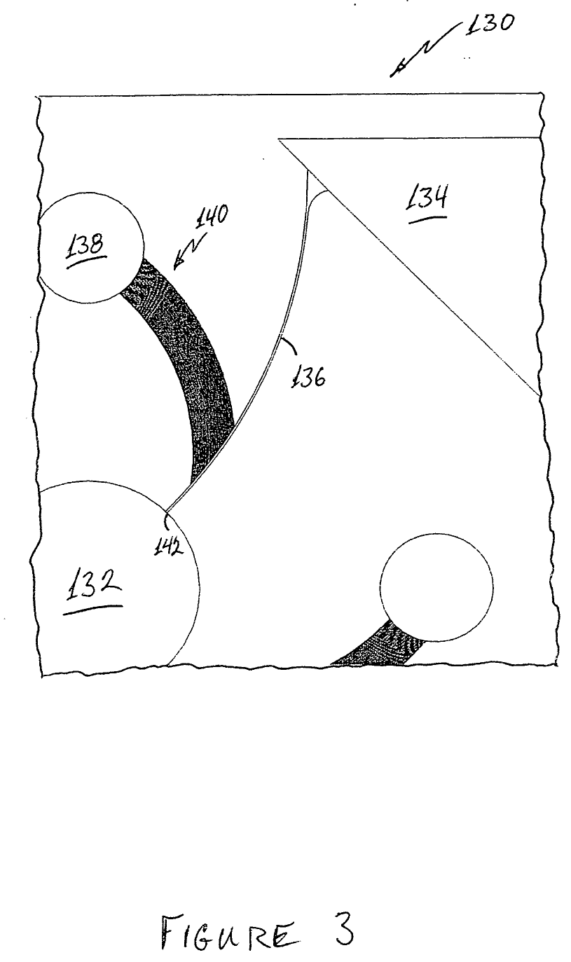

In addition to the fluid source chamber 132, the micro-cartridge 130 has a particulate collection chamber 134 defined by a portion of the micro-cartridge 130 spaced apart from the fluid source chamber 132. A main channel 136 extends between the fluid source chamber 132 and particulate collection chamber 134. The main channel 136 is a curved channel in this embodiment of the invention. A curved main channel can provide good results for some embodiments of this invention, for example for the case in which the micro-cartridge is for use with a centrifuge. Some embodiments of this invention may have straight main channels and/or main channels having curved structures different from those illustrated for the embodiment of FIG. 2 without departing from some general concepts of this invention. A liquid collection chamber 138 is defined by a portion of the micro-cartridge 130 at a location spaced apart from the main channel 136. A plurality of capillary channels 140 are defined by a portion of the micro-cartridge 130 extending from the main channel 136 to the liquid collection chamber 138. The plurality of capillary channels 140 are narrow channels closely spaced and thus appear to be a solid, thick line in FIG. 2. Each capillary channel of the plurality of capillary channels 140 is narrower that the main channel 136 to facilitate the flow of serum from the main channel 136 through the capillary channels 140. FIG. 3 illustrates a portion of the micro-cartridge 130 in more detail. FIG. 3 better illustrates that the plurality of capillary channels 140 are a large number of closely spaced channels.

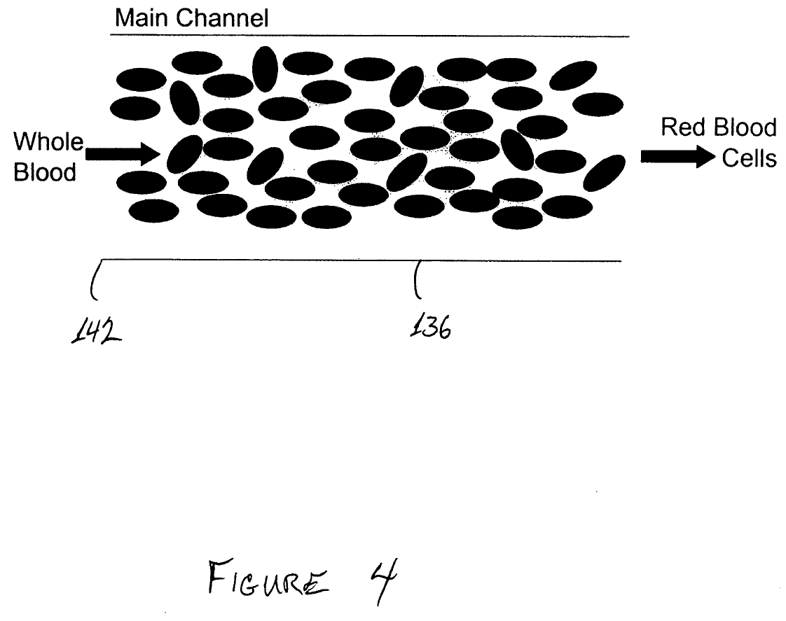

The width and depth of the main channel 136 and capillary channels 140 are selected according to the particular application, based on the size of the particles suspended in the liquid of the composite fluid. FIG. 4 is a schematic illustration to help illustrate concepts for the design of the main channel 136 for the case in which the fluid is blood. The blood enters the main channel 136 at an entrance port 142 from the fluid source chamber 132 (FIG. 3). The Fahraeus effect is exhibited by blood flowing through narrow tubes. In particular, red blood cells have been observed to move through the center of the tube faster than the blood as a whole, leaving serum lining the walls of the tube when the diameter of the tube is less than about 300 micrometers. The fluid flow varies from near zero at the wall of the tube to a maximum in the center of the tube. Mechanical interactions between blood and tube walls lead to high concentrations of red blood cells in the center of the tube, and the formation of a plasma layer along the wall of the tube. This is called axial migration. Slow moving blood has a tendency to aggregate and clot. In addition to capillary action of the main channel, centrifugation can provide some motive force to propel red blood cells through narrow channels and decrease blood viscosity by increasing shear flow. Further, centrifugation can provide a method to orient RBC along the edge opposite from the separation edge. The increased capillary suction from smaller channel sizes may otherwise draw RBC into the separation channels, obstructing their flow. However, rotation speeds should not be so high as to disrupt the Fahraeus effect. Blood viscosity decreases as shear flow increases. This is a phenomenon known as “shear thinning.” FIG. 4 schematically illustrates these effects for a section of a main channel 136 of a micro-cartridge according to the current invention.

In this embodiment of the current invention, as applied to a blood test system, the current inventor has found that a main channel having a width of less than about 300 micrometers works well. In particular, the Fahraeus effect is exhibited, the blood flow through the main channel is laminar flow and some capillary action is exhibited. In this case, it has been found that for channels less than about 50 micrometers, the blood begins to have a tendency to clot. Therefore, good results for applying this embodiment to blood test equipment have been obtained with main channels in the range of about 50 micrometers to 300 micrometers. For applications to test other types of fluids, other than blood, one may wish to select main channels having sizes optimized for the particular application.

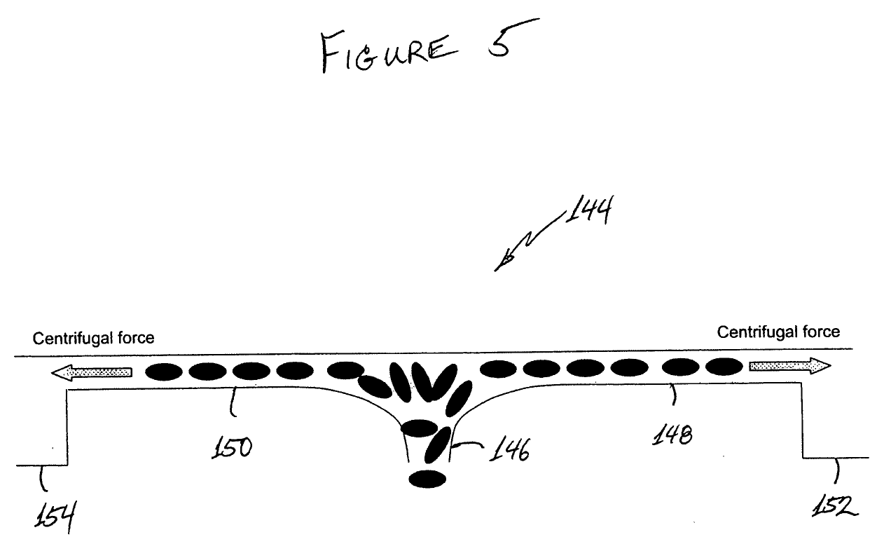

FIG. 5 is a schematic illustration of a micro-cartridge 144 in a cross sectional view, according to an embodiment of this invention. In the micro-cartridge 144 a fluid source chamber 146 feeds into main channels 148 and 150. Particulate collection chambers 152 and 154 connect with the main channels 148 and 150, respectively. Red blood cells are typically about 8 micrometers in diameter and about 2 micrometers thick. Consequently, if one were to make the main channel less than about 8 micrometers deep, it would result in red blood cells aligning with their long dimensions substantially along the direction of flow. In particular, a main channel depth between 5 to 20 micrometers was found to be suitable.

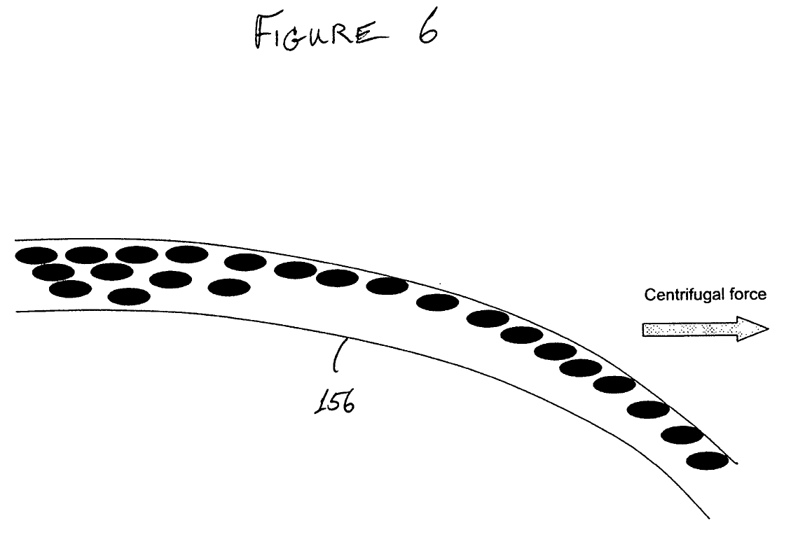

FIG. 6 is a schematic illustration of a portion of a main channel 156 according to an embodiment of the current invention. In an embodiment in which a micro-cartridge according to this invention is attached to a centrifuge, the main channel 156 can be structured in a curved path so that red blood cells will tend to congregate more towards one wall of the main channel compared to an opposing wall. The main channel 156 is shown in a plane view in which the rotation is counterclockwise in an axis substantially perpendicular to the plane of the drawing.

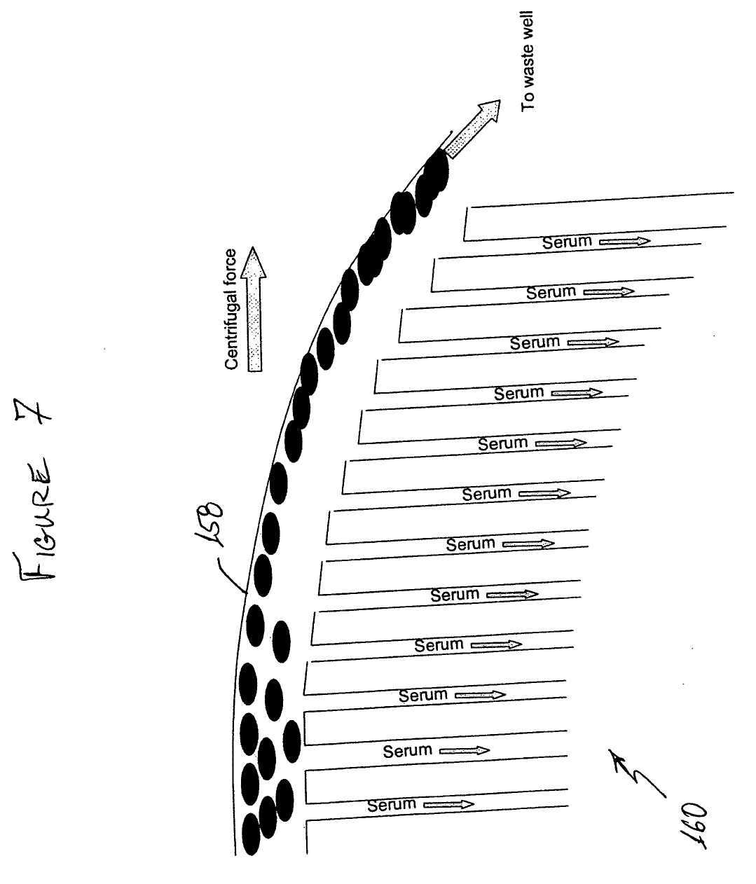

FIG. 7 is a schematic illustration of a main channel 158 in the vicinity of a plurality of capillary channels 160, as viewed from the top. Again, this is an application of this embodiment to the separation of blood serum from red blood cells and other particulate matter and the micro-cartridge is structured to be attached to a centrifuge and rotated counterclockwise about an axis of rotation substantially perpendicular to the plane of the drawing. Red blood cells are shown schematically in which they become more concentrated towards one edge of the main channel 158 away from openings to the plurality of capillary channels 160. This helps prevent the red blood cells and other particulate matter from clogging the capillary channels 160.

The Fahraeus-Lindqvist effect is exhibited by the plurality of capillary channels in which the serum of blood reaches a minimum viscosity for capillaries having a width in a range from about 3.5 micrometers to about 7 micrometers. At about 7 micrometers, the viscosity tends to increase and below about 3.5 micrometers the viscosity of the blood serum also increases. Thus a width of each capillary channel within the range of widths from about 2 micrometers to about 8 micrometers are suitable. Blood serum from whole blood flowing through the main channel 158 will wick off, while blood containing a concentration of the red blood cells and other particulate matter will be directed to the particulate collection chamber, referred to as the “waste well” in the embodiment of FIG. 7. In this embodiment, tests will be performed on serum separated from whole blood while no tests will be performed on the portion directed to the particulate collection chamber, and thus the term “waste well” in this case. However, the invention is not limited to only performing tests on one of the separated components of the fluid.

In operation, the micro-cartridge 130 according to the embodiment of FIGS. 2 and 3 is attached in the cartridge holder 108 of the hand-held centrifuge 104 to rotate substantially about an axis perpendicular to FIG. 2 and substantially through the center of the fluid source chamber 132. The rotation will be clockwise in FIG. 2. A fluid to be tested, such as whole blood, is deposited in the liquid source chamber 132. For example, blood may be deposited through an attached micro-needle array, or may be deposited manually by an external device. One may select hydrophilic materials for the structures of the micro-cartridge 132 that come in contact with the fluid to encourage better flow and/or spreading of fluid deposited in the micro-cartridge 130. The spreading of fluid deposited in the fluid source chamber 132 towards main channel 136 permits fluid to be drawn into the main channel 136 by capillary action. Alternatively, or in addition to such spreading within the fluid source chamber and capillary action of the main channel, other motive forces may be provided to the fluid. For example, flow can be driven by centrifugation, electro kinetics, capillary action, micro fabricated pumps or other mechanical pumping structures. In the current example for one embodiment of the invention, blood flow is driven by a combination of centrifugation and capillary action through the main channel 136. The more dense particulate matter, such as red blood cells, tend to move toward the particulate collection chamber 132 as well as moving more towards one wall of the main channel 136 along the curved portion (see FIG. 7). In addition, the particulate matter, such as the red blood cells, tend to flow more through the center of the main channel 136 leaving liquid such as blood serum, along the edges of the main channel 136. Consequently, the fluid collecting in the particulate collection chamber contains a higher concentration of the particulate matter than the whole blood.

Liquid from the fluid is wicked off by capillary action through the plurality of capillary channels 140 and directed to the liquid collection chamber 138. In the example of blood test equipment, tests and/or analyses may be performed on the serum separated off into the liquid collection chambers. For example, each chamber may contain a reagent to mix with the blood serum. One may include different reagents in each of the four, in the current embodiment, liquid collection chambers to substantially simultaneously perform four different tests of the blood serum. The reagents could be liquid reagents, either contained within the liquid collection chambers, or could be introduced into the chambers in some embodiments. The reagents may also be dry reagents, for example contained within the liquid collection chambers. For such embodiments, one may utilize optically transparent materials in constructing the micro-cartridge 130, at least in portions to allow for observations of light reflected, transmitted, scattered and/or absorbed from liquid in the liquid collection chambers. However, this invention is not limited to how and/or whether one performs tests on liquid collected in the liquid collection chamber and/or fluid collected in the particulate collection chamber.

Micro-cartridges according to the current invention may be constructed from a variety of materials selected according to the desired application. In some embodiments, one may wish to select materials that are relatively transparent to visible and/or infra-red light. Polycarbonate (PC), Cyclic Olefin Copolymers (COC), Polyethylene Terephthalate (PET), Poly methyl methacrylate (PMMA), Polypropylene (PP), Polystyrene (PS), glass, fused silica, Polydimethylsiloxane (PDMS) are suitable optically transparent materials for some applications. The general concepts of this invention are not limited to the use of only these materials.

The embodiments illustrated and discussed in this specification are intended only to teach those skilled in the art the best way known to the inventors at the time of filing to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

I claim:

1. A micro-cartridge for a fluid test device, comprising:
a fluid source chamber defined by a portion of said micro-cartridge;
a particulate collection chamber defined by a second portion of said micro-cartridge spaced apart from said fluid source chamber;
a main channel defined by a portion of said micro-cartridge extending from said fluid source chamber to said particulate collection chamber;
a liquid collection chamber defined by a portion of said micro-cartridge spaced apart from said main channel; and
a plurality of capillary channels formed by a portion of said micro-cartridge extending from said main channel to said liquid collection chamber,
wherein said main channel has a width that is within a range of about 50 μm to 300 μm, and
wherein said plurality of capillary channels are each narrower than said main channel.

2. A micro-cartridge according to claim 1, wherein said main channel has a depth of about 5 to 20 μm.

3. A micro-cartridge according to claim 1, wherein said main channel has a uniformity in width along an entire length of said main channel such that no two sections of said main channel have widths that differ by more than about 100 μm.

4. A micro-cartridge according to claim 1, wherein said main channel is a curved channel.

5. A micro-cartridge according to claim 1, wherein said plurality of capillary channels each have a width that is within a range of about 2 μm to 20 μm.

6. A micro-cartridge according to claim 5, wherein none of said plurality of capillary channels has a width less than about 3.5 μm.

7. A micro-cartridge according to claim 6, wherein none of said plurality of capillary channels has a width greater than about 8 μm.

8. A micro-cartridge according to claim 1, wherein said plurality of capillary channels are a plurality of curved capillary channels.

9. A micro-cartridge according to claim 1, wherein said fluid source chamber, said particulate collection chamber, said liquid collection chamber, said main channel and said plurality of capillary channels are stamped or etched into a plastic or glass substrate.

10. A method of separating liquid from a composite fluid, comprising:
obtaining a sample of said composite fluid, wherein said composite fluid comprises a liquid and particulate matter suspended in said liquid; and
delivering at least a portion of said composite fluid proximate an-entrance port of a main channel of a separating device;
wherein at least a portion of said composite fluid flows through said main channel and past a plurality of capillary channels of said separating device;
wherein said main channel has a width within a range of about 100 μm to 300 μm,
wherein at least a portion of said liquid material is separated from said fluid flowing through said main channel by capillary action of said plurality of capillary channels, and
wherein each capillary channel of said plurality of capillary channels is narrower than said main channel.

11. A method of separating liquid from a composite fluid according to claim 10, wherein said composite fluid is caused to flow through said main channel at least partly by capillary action from said main channel.

12. A method of separating liquid from a composite fluid according to claim 10, wherein said portion of said composite fluid delivered proximate said entrance port of said main channel is delivered onto a surface of hydrophilic material allowing said composite fluid to spread across said surface toward said port of said main channel.

13. A method of separating liquid from a composite fluid according to claim 10, further comprising centrifuging said portion of said composite fluid to cause at least some separation of said particulate matter from said liquid.

14. A method of separating liquid from a composite fluid according to claim 13, wherein said main channel is curved proximate ports of said plurality of capillary channels to help prevent said particulate matter from clogging said capillary channels.

15. A method of separating liquid from a composite fluid according to claim 10, wherein said main channel has a depth between 5 to 20 μm.

16. A method of separating liquid from a composite fluid according to claim 10, wherein each capillary channel of said plurality of capillary channels is narrower than a maximum dimension of particles of said composite fluid from which said liquid is being separated such that said particles are prevented from passing through said capillary channels.

17. A method of separating liquid from a composite fluid according to claim 16, wherein each capillary channel of said plurality of capillary channels has a width within a range of about 2 μm to 20 μm.

18. A method of separating liquid from a composite fluid according to claim 17, wherein said composite fluid is blood, said liquid is blood serum, and said particulate matter includes red blood cells.

19. A hand-held test device, comprising:
a hand-held centrifuge; and
a micro-cartridge adapted to be attached to and detached from said hand-held centrifuge,
wherein said micro-cartridge comprises a main channel in which a first-stage separation of a fluid into constituent parts is effected, and a plurality of capillary channels in which liquid is separated from said fluid by capillary action.

20. A hand-held test device according to claim 19, further comprising a data analysis and storage device in communication with said hand-held centrifuge and micro-cartridge assembly.
